(19) United States
(12) Patent Application Publication
(10) Pub. No.: US 2023/0394600 A1
(43) Pub. Date: Dec. 7, 2023

(54) METHOD AND SYSTEM FOR CARBON IMPACT TRACKING

(71) Applicant: JPMorgan Chase Bank, N.A., New York, NY (US)

(72) Inventors: Arockia Prabakar AMALRAJ, Westerville, OH (US); Timothy F. ROBERTS, Upper Arlington, OH (US)

(73) Assignee: JPMorgan Chase Bank, N.A., New York, NY (US)

(21) Appl. No.: 18/143,711

(22) Filed: May 5, 2023

Related U.S. Application Data
(60) Provisional application No. 63/365,991, filed on Jun. 7, 2022.

(51) Int. Cl. G06Q 50/06; G06Q 30/0283

(52) U.S. Cl. CPC G06Q 50/06; G06Q 30/0283

(57) ABSTRACT

A method for carbon impact tracking by providing a mechanism for generating carbon impact summaries with respect to a wide variety of applications and products is provided. The method includes: receiving first information that relates to an amount of energy consumed by a first entity, such as a software application, a platform hosting a software suite, or a consumer product, within a predetermined time interval; receiving second information that relates to a location at which the energy is consumed and a technology used for generating the energy; converting the first information and the second information into metrics that indicate a carbon impact associated with the first entity; and generating a report of the results. The metrics may include one or more of an amount of kilograms of carbon dioxide (CO2), a number of kilowatt-hours of electricity, and a dollar equivalent of a measurement of a carbon social cost.

### CROSS-REFERENCE TO RELATED APPLICATIONS

This application claims priority benefit from U.S. Provisional Application No. 63/365,991, filed Jun. 7, 2022, which is hereby incorporated by reference in its entirety.

### BACKGROUND

### 1. Field of the Disclosure

This technology generally relates to methods and systems for tracking environmental effects of various applications and products, and more particularly to methods and systems for carbon impact tracking by providing a mechanism for generating carbon impact summaries in an easy-to-deploy and scalable manner with respect to a wide variety of applications and products.

### 2. Background Information

Accurate reporting of energy and carbon usage is essential for understanding potential climate impacts of platforms and software running on those platforms. As a consequence, there is a need for a framework to measure carbon emissions arising from such platforms, software, and associated components. Further, there is a need to identify mitigation strategies for reducing and/or offsetting emissions by using sustainable and responsible software engineering patterns.

### SUMMARY

The present disclosure, through one or more of its various aspects, embodiments, and/or specific features or sub-components, provides, inter alia, various systems, servers, devices, methods, media, programs, and platforms for carbon impact tracking by providing a mechanism for generating carbon impact summaries in an easy-to-deploy and scalable manner with respect to a wide variety of applications and products.

According to an aspect of the present disclosure, a method for tracking carbon emissions is provided. The method is implemented by at least one processor. The method includes: receiving, by the at least one processor, first information that relates to an amount of energy that is consumed by a first entity within a predetermined time interval; receiving, by the at least one processor, second information that relates to a location at which the energy is consumed and a technology used for generating the energy; calculating, by the at least one processor based on the first information and the second information, at least one metric that indicates a carbon impact associated with the first entity; and generating, by the at least one processor, a report that includes third information that relates to the carbon impact associated with the first entity.

The method may further include: displaying a dashboard that includes a graphical user interface (GUI) that provides at least one prompt for facilitating user input that relates to at least one from among the first information and the second information; and after the report is generated, displaying the third information via the GUI.

The first entity may include at least one from among a software application, a group of software applications, a platform that hosts at least one software application, a consumer product, and a hardware component that is usable in connection with at least one consumer product.

The predetermined time interval may include at least one from among one hour, one day, one week, one month, six months, and one year.

The at least one metric may include at least one from among an amount of kilograms of carbon dioxide (CO2), a number of kilowatt-hours of electricity, and a number of dollars that relates to a measurement of a carbon social cost.

The method may further include determining, by the at least one processor based on the first information, the second information, and the at least one metric, at least one proposed mitigation action for reducing the carbon impact associated with the first entity. The report may include fourth information that relates to the at least one proposed mitigation action.

The at least one proposed mitigation action may include at least one from among a first mitigation action that relates to green architecture and design patterns, a second mitigation action that relates to a green cloud, a third mitigation action that relates to green engineering, a fourth mitigation action that relates to green machine learning, and a fifth mitigation action that relates to green mobility.

The third mitigation action that relates to green engineering may include a mitigation action that relates to at least one from among a use of a particular programming language, a use of a platform that includes caching, and a use of a library that includes caching.

The fifth mitigation action that relates to green mobility may include a mitigation action that relates to inducing users to exercise at least one green digital habit that corresponds to a sustainability score.

According to another exemplary embodiment, a computing apparatus for tracking carbon emissions is provided. The computing apparatus includes a processor; a memory; a display; and a communication interface coupled to each of the processor, the memory, and the display. The processor is configured to: receive, via the communication interface, first information that relates to an amount of energy that is consumed by a first entity within a predetermined time interval; receive, via the communication interface, second information that relates to a location at which the energy is consumed and a technology used for generating the energy; calculate, based on the first information and the second information, at least one metric that indicates a carbon impact associated with the first entity; and generate a report that includes third information that relates to the carbon impact associated with the first entity.

The processor may be further configured to: cause the display to display a dashboard that includes a graphical user interface (GUI) that provides at least one prompt for facilitating user input that relates to at least one from among the first information and the second information; and after the report is generated, cause the display to display the third information via the GUI.

The first entity may include at least one from among a software application, a group of software applications, a platform that hosts at least one software application, a consumer product, and a hardware component that is usable in connection with at least one consumer product.

The predetermined time interval may include at least one from among one hour, one day, one week, one month, six months, and one year.

The at least one metric may include at least one from among an amount of kilograms of carbon dioxide (CO2), a number of kilowatt-hours of electricity, and a number of dollars that relates to a measurement of a carbon social cost.

The processor may be further configured to determine, based on the first information, the second information, and the at least one metric, at least one proposed mitigation action for reducing the carbon impact associated with the first entity. The report may include fourth information that relates to the at least one proposed mitigation action.

The at least one proposed mitigation action may include at least one from among a first mitigation action that relates to green architecture and design patterns, a second mitigation action that relates to a green cloud, a third mitigation action that relates to green engineering, a fourth mitigation action that relates to green machine learning, and a fifth mitigation action that relates to green mobility.

The third mitigation action that relates to green engineering may include a mitigation action that relates to at least one from among a use of a particular programming language, a use of a platform that includes caching, and a use of a library that includes caching.

The fifth mitigation action that relates to green mobility may include a mitigation action that relates to inducing users to exercise at least one green digital habit that corresponds to a sustainability score.

According to yet another exemplary embodiment, a non-transitory computer readable storage medium storing instructions for tracking carbon emissions is provided. The storage medium includes executable code which, when executed by a processor, causes the processor to: receive first information that relates to an amount of energy that is consumed by a first entity within a predetermined time interval; receive second information that relates to a location at which the energy is consumed and a technology used for generating the energy; calculate, based on the first information and the second information, at least one metric that indicates a carbon impact associated with the first entity; and generate a report that includes third information that relates to the carbon impact associated with the first entity.

When executed by the processor, the executable code may further cause the processor to: cause a display to display a dashboard that includes a graphical user interface (GUI) that provides at least one prompt for facilitating user input that relates to at least one from among the first information and the second information; and after the report is generated, cause the display to display the third information via the GUI.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for carbon impact tracking by providing a mechanism for generating carbon impact summaries in an easy-to-deploy and scalable manner with respect to a wide variety of applications and products.

FIG. 4 is a flowchart of an exemplary process for implementing a method for carbon impact tracking by providing a mechanism for generating carbon impact summaries in an easy-to-deploy and scalable manner with respect to a wide variety of applications and products.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

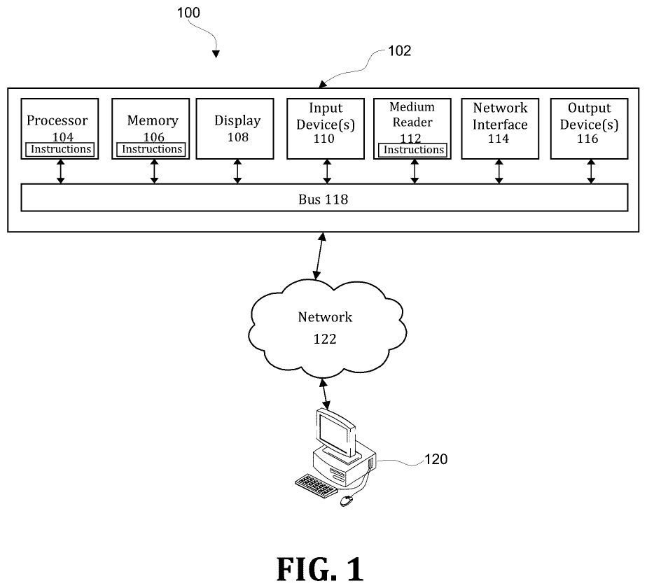

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for carbon impact tracking by providing a mechanism for generating carbon impact summaries in an easy-to-deploy and scalable manner with respect to a wide variety of applications and products.

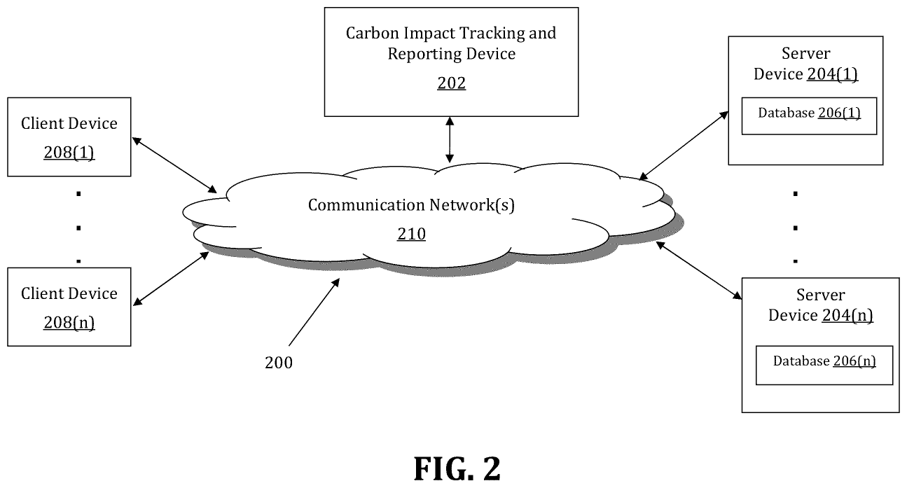

Referring to FIG. 2, a schematic of an exemplary network environment 200 for implementing a method for carbon impact tracking by providing a mechanism for generating carbon impact summaries in an easy-to-deploy and scalable manner with respect to a wide variety of applications and products is illustrated. In an exemplary embodiment, the method is executable on any networked computer platform, such as, for example, a personal computer (PC).

The method for carbon impact tracking by providing a mechanism for generating carbon impact summaries in an easy-to-deploy and scalable manner with respect to a wide variety of applications and products may be implemented by a Carbon Impact Tracking and Reporting (CITR) device 202. The CITR device 202 may be the same or similar to the computer system 102 as described with respect to FIG. 1. The CITR device 202 may store one or more applications that can include executable instructions that, when executed by the CITR device 202, cause the CITR device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CITR device 202 itself, may be located in virtual server(s) running in a cloud-based computing environment rather than being tied to one or more specific physical network computing devices. Also, the application(s) may be running in one or more virtual machines (VMs) executing on the CITR device 202. Additionally, in one or more embodiments of this technology, virtual machine(s) running on the CITR device 202 may be managed or supervised by a hypervisor.

In the network environment 200 of FIG. 2, the CITR device 202 is coupled to a plurality of server devices 204(1)-204(n) that hosts a plurality of databases 206(1)-206(n), and also to a plurality of client devices 208(1)-208(n) via communication network(s) 210. A communication interface of the CITR device 202, such as the network interface 114 of the computer system 102 of FIG. 1, operatively couples and communicates between the CITR device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CITR device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CITR devices that efficiently implement a method for carbon impact tracking by providing a mechanism for generating carbon impact summaries in an easy-to-deploy and scalable manner with respect to a wide variety of applications and products.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CITR device 202 may be a standalone device or integrated with one or more other devices or apparatuses, such as one or more of the server devices 204(1)-204(n), for example. In one particular example, the CITR device 202 may include or be hosted by one of the server devices 204(1)-204(n), and other arrangements are also possible. Moreover, one or more of the devices of the CITR device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CITR device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical carbon emissions data that relates to applications, products, and components, and environmental impact metrics data that is usable for analysis and mitigation strategies.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CITR device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CITR device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CITR device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CITR device 202, the server devices 204(1)-204(n), or the client devices 208(1)-208(n), for example, may be configured to operate as virtual instances on the same physical machine. In other words, one or more of the CITR device 202, the server devices 204(1)-204(n), or the client devices 208(1)-208(n) may operate on the same physical device rather than as separate devices communicating through communication network(s) 210. Additionally, there may be more or fewer CITR devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

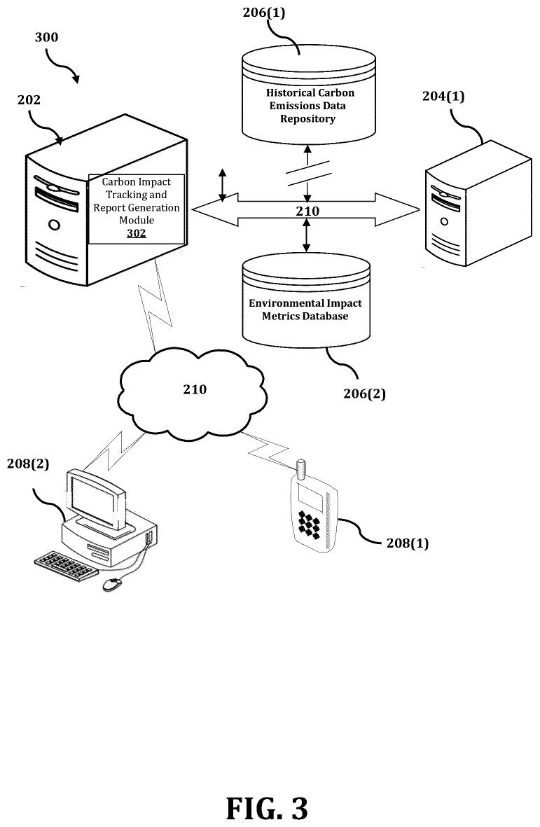

The CITR device 202 is described and illustrated in FIG. 3 as including a carbon impact tracking and report generation module 302, although it may include other rules, policies, modules, databases, or applications, for example. As will be described below, the carbon impact tracking and report generation module 302 is configured to implement a method for carbon impact tracking by providing a mechanism for generating carbon impact summaries in an easy-to-deploy and scalable manner with respect to a wide variety of applications and products.

An exemplary process 300 for implementing a mechanism for carbon impact tracking by providing a mechanism for generating carbon impact summaries in an easy-to-deploy and scalable manner with respect to a wide variety of applications and products by utilizing the network environment of FIG. 2 is illustrated as being executed in FIG. 3. Specifically, a first client device 208(1) and a second client device 208(2) are illustrated as being in communication with CITR device 202. In this regard, the first client device 208(1) and the second client device 208(2) may be “clients” of the CITR device 202 and are described herein as such. Nevertheless, it is to be known and understood that the first client device 208(1) and/or the second client device 208(2) need not necessarily be “clients” of the CITR device 202, or any entity described in association therewith herein. Any additional or alternative relationship may exist between either or both of the first client device 208(1) and the second client device 208(2) and the CITR device 202, or no relationship may exist.

Further, CITR device 202 is illustrated as being able to access a historical carbon emissions data repository 206(1) and an environmental impact metrics database 206(2). The carbon impact tracking and report generation module 302 may be configured to access these databases for implementing a method for carbon impact tracking by providing a mechanism for generating carbon impact summaries in an easy-to-deploy and scalable manner with respect to a wide variety of applications and products.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CITR device 202 via broadband or cellular communication. Of course, these embodiments are merely exemplary and are not limiting or exhaustive.

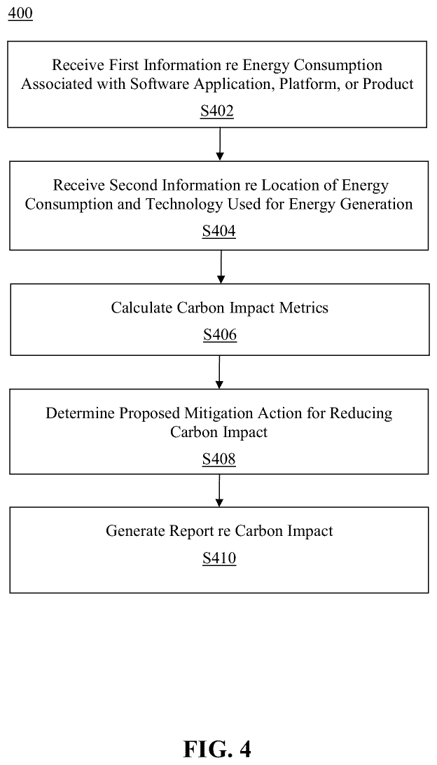

Upon being started, the carbon impact tracking and report generation module 302 executes a process for carbon impact tracking by providing a mechanism for generating carbon impact summaries in an easy-to-deploy and scalable manner with respect to a wide variety of applications and products. An exemplary process for carbon impact tracking by providing a mechanism for generating carbon impact summaries in an easy-to-deploy and scalable manner with respect to a wide variety of applications and products is generally indicated at flowchart 400 in FIG. 4.

In process 400 of FIG. 4, at step S402, the carbon impact tracking and report generation module 302 receives first information that relates to an amount of energy that is consumed by a first entity within a predetermined time interval. The first entity may include any one or more of a software application, a group or suite of software applications, a platform that hosts software applications, a consumer product, and/or a hardware component that is usable in connection with at least one consumer product. The predetermined time interval may include at least one from among one hour, one day, one week, one month, six months, and/or one year. In an exemplary embodiment, the first information may be received from a user input that is provided via a graphical user interface (GUI) that is displayable as part of a digital dashboard that appears on a computer screen of the user. The GUI may include at least one prompt that facilitates entry of user input, such as, for example, entry of energy consumption data that is usable as a portion of the first information.

At step S404, the carbon impact tracking and report generation module 302 receives second information that relates to a location at which the energy is consumed and information that relates to a technology used for generating the energy. In an exemplary embodiment, at least a portion of the second information may be received via user input that is provided through a GUI that is displayed as part of a digital dashboard. The second information may be understood as being equivalent to a carbon intensity that varies based on the location and the technology used for generating the energy.

At step S406, the carbon impact tracking and report generation module 302 uses the first information and the second information to calculate one or more metrics that indicate a carbon impact associated with the first entity. In an exemplary embodiment, the metrics may include any one or more of metric includes at least one from among an equivalent amount of kilograms of carbon dioxide (CO2) associated with the first entity, a number of kilowatt-hours of electricity associated with the first entity, and a number of dollars that relates to a measurement of a carbon social cost associated with the first entity.

At step S408, the carbon impact tracking and report generation module 302 determines a proposed mitigation action for reducing a carbon impact associated with the first entity. In an exemplary embodiment, the proposed mitigation action may include any possible suggestion for increasing energy efficiency and/or reducing or offsetting energy consumption that is consistent with the first information, the second information, and the metrics calculated in step S406.

At step S410, the carbon impact tracking and report generation module 302 generates a carbon impact report that includes third information that is generated as a result of performing steps S402, S404, S406, and S408. In an exemplary embodiment, the report includes the metrics generated in step S406 and a message that notifies the user of the proposed mitigation action determined in step S408. In an exemplary embodiment, the report may be displayed via a GUI that is shown on a computer screen of a user.

From a technology standpoint, carbon accounting may be defined at an application level or at a product level with respect to a group of applications. In an exemplary embodiment, carbon accounting entails the measuring and non-monetary valuation of carbon and greenhouse gas emissions in a form that is equivalent to units of carbon dioxide (i.e., CO2). In particular, for a given application, group of applications, product, or component, an objective of carbon accounting is to determine an amount of carbon that is released into the Earth's atmosphere as a result of the energy that is consumed in operating and building the various applications and/or software products. The result may then be used to assess monetary impacts through the social cost of carbon emission.

A first step is to measure or gather CO2 emissions from an infrastructure standpoint. An infrastructure stack may include any one or more of the following: an on-premises physical server infrastructure; an on-premises virtual server infrastructure; an on-premises private cloud platform; and/or a public cloud platform, such as an Amazon Web Services (AWS) public cloud platform, a Google public cloud platform, and/or an Azure public cloud platform.

Energy consumption of a system may be measured in joules (J) or watt-hours, as an amount of energy needed to operate a system and that is spent during a lifecycle of the system. Energy consumption components may include any one or more of the following: cooling components; lighting components; power conversion components; networking hardware components; and server/storage components, which may be further characterized as being central processing unit (CPU) components and random access memory (RAM) components.

In an exemplary embodiment, utilization metrics may be translated into data that reflects corresponding physical realities. A tool that is usable for tracking hardware energy consumption may measure various metrics, such as energy consumption as expressed in joules, a number of CPU hours or graphics processing unit (GPU) hours of operational time (i.e., runtime), an interface time that refers to a total time required to run one end-to-end interface, and/or a wall clock timing that refers to a total time required to run or train a machine learning model.

In an exemplary embodiment, an objective of the present disclosure is to provide a framework for generating carbon impact summaries in an easy-to-deploy and scalable manner with respect to a wide variety of applications and products, together with additional dependencies showing detailed energy, carbon, and compute metrics. For example, a carbon impact summary may indicate that a particular product contributed an equivalent of x kilograms of CO2 to the atmosphere and consumed y kilowatt-hours of electricity, thus having a carbon-specific social cost of z, by running a certain number of applications for one day.

In an exemplary embodiment, there are several considerations for implementing the framework, including the following: 1) types of core processors, i.e., CPU or GPU or both; 2) number of cores; 3) hardware models; 4) application run times; energy grid regions where applications are running, based on Internet Protocol (IP) address; 6) average carbon intensity in each energy grid region; 7) CPU and GPU power draws; 8) memory usage; 9) real time CPU frequency (as measured in Hertz (Hz)); and disk write speeds. For example, referring again to FIG. 1, for each type of component and/or peripheral device that is included in computer system 102, the framework is implementable by including information that relates to usage and runtime thereof, which may be measured by determining a respective compute time and a respective energy usage for each corresponding component and/or peripheral device.

In an exemplary embodiment, a carbon footprint may be calculated by estimating an energy draw of a particular algorithm and a corresponding carbon intensity of producing the estimated energy draw at a given location. This calculation may be expressed as follows: Carbon footprint=energy needed*carbon intensity.

In this equation, the “energy needed” may be calculated based on the following, where PUE refers to power usage effectiveness and PSF refers to pragmatic scaling factor: Energy needed=runtime*(power draw for cores*usage+power draw for memory)*PUE*PSF. The power draw for the computing cores may depend on the model and the number of cores, and the memory power draw may only depend on the size of the available memory. The usage factor corrects for the real core usage; in this regard, a default value for the usage factor is 1, which reflects full usage. The PUE measures how much extra energy is needed to operate a data center, i.e., re cooling, lighting, and any other energy consumption component. The PSF is used to account for multiple identical runs, such as, for example, runs performed for testing or optimization.

The carbon intensity depends on the location and the technologies used to produce electricity in that location. By contrast, the energy needed is independent of the location.

Mitigation: In an exemplary embodiment, the present disclosure also contemplates implementing a mitigation strategy that entails the use of responsible software engineering patterns.

The mitigation strategy may include a first aspect that relates to green architecture and design patterns. In this aspect, specific coding and design patterns are more energy efficient than others. Optimizing the code efficiency and leveraging energy impacts and carbon emissions reported from the carbon impact tracking and report generation module 302 may be implemented.

The mitigation strategy may include a second aspect that relates to a green cloud. In this aspect, a sustainable cloud is an objective. Container and virtual machine placement and migration have distinct energy profiles and efficiencies, and there are tradeoffs with performance, reliability, and other metrics.

The mitigation strategy may include a third aspect that relates to green engineering. Some programming languages are more energy efficient than others for specific types of programming tasks. Platforms and libraries that include features such as caching may make a significant difference to run-time energy usage.

The mitigation strategy may include a fourth aspect that relates to green machine learning. One green machine learning objective is to choose machine learning parameters that limit epochs as part of model training. Another green machine learning objective is to limit data size consideration and data quality issues while training data sets in order to reduce energy waste arising from sub-optimal models.

The mitigation strategy may include a fifth aspect that relates to green mobility. One green mobility objective is to make use of personalized and community-wide recommendations with respect to sustainability score in order to induce customers and product users to green digital habits, such as, for example, offsetting carbon emission by planting a tree for every new account opening.

Accordingly, with this technology, an optimized process for carbon impact tracking by providing a mechanism for generating carbon impact summaries in an easy-to-deploy and scalable manner with respect to a wide variety of applications and products is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for tracking carbon emissions, the method being implemented by at least one processor, the method comprising:
receiving, by the at least one processor, first information that relates to an amount of energy that is consumed by a first entity within a predetermined time interval;
receiving, by the at least one processor, second information that relates to a location at which the energy is consumed and a technology used for generating the energy;
calculating, by the at least one processor based on the first information and the second information, at least one metric that indicates a carbon impact associated with the first entity; and
generating, by the at least one processor, a report that includes third information that relates to the carbon impact associated with the first entity.

2. The method of claim 1, further comprising:
displaying a dashboard that includes a graphical user interface (GUI) that provides at least one prompt for facilitating user input that relates to at least one from among the first information and the second information; and
after the report is generated, displaying the third information via the GUI.

3. The method of claim 1, wherein the first entity includes at least one from among a software application, a group of software applications, a platform that hosts at least one software application, a consumer product, and a hardware component that is usable in connection with at least one consumer product.

4. The method of claim 1, wherein the predetermined time interval includes at least one from among one hour, one day, one week, one month, six months, and one year.

5. The method of claim 1, wherein the at least one metric includes at least one from among an amount of kilograms of carbon dioxide (CO2), a number of kilowatt-hours of electricity, and a number of dollars that relates to a measurement of a carbon social cost.

6. The method of claim 1, further comprising determining, by the at least one processor based on the first information, the second information, and the at least one metric, at least one proposed mitigation action for reducing the carbon impact associated with the first entity,
wherein the report includes fourth information that relates to the at least one proposed mitigation action.

7. The method of claim 6, wherein the at least one proposed mitigation action includes at least one from among a first mitigation action that relates to green architecture and design patterns, a second mitigation action that relates to a green cloud, a third mitigation action that relates to green engineering, a fourth mitigation action that relates to green machine learning, and a fifth mitigation action that relates to green mobility.

8. The method of claim 7, wherein the third mitigation action that relates to green engineering comprises a mitigation action that relates to at least one from among a use of a particular programming language, a use of a platform that includes caching, and a use of a library that includes caching.

9. The method of claim 7, wherein the fifth mitigation action that relates to green mobility comprises a mitigation action that relates to inducing users to exercise at least one green digital habit that corresponds to a sustainability score.

10. A computing apparatus for tracking carbon emissions, the computing apparatus comprising:
a processor;
a memory;
a display; and
a communication interface coupled to each of the processor, the memory, and the display,
wherein the processor is configured to:
receive, via the communication interface, first information that relates to an amount of energy that is consumed by a first entity within a predetermined time interval;
receive, via the communication interface, second information that relates to a location at which the energy is consumed and a technology used for generating the energy;
calculate, based on the first information and the second information, at least one metric that indicates a carbon impact associated with the first entity; and
generate a report that includes third information that relates to the carbon impact associated with the first entity.

11. The computing apparatus of claim 10, wherein the processor is further configured to:
cause the display to display a dashboard that includes a graphical user interface (GUI) that provides at least one prompt for facilitating user input that relates to at least one from among the first information and the second information; and
after the report is generated, cause the display to display the third information via the GUI.

12. The computing apparatus of claim 10, wherein the first entity includes at least one from among a software application, a group of software applications, a platform that hosts at least one software application, a consumer product, and a hardware component that is usable in connection with at least one consumer product.

13. The computing apparatus of claim 10, wherein the predetermined time interval includes at least one from among one hour, one day, one week, one month, six months, and one year.

14. The computing apparatus of claim 10, wherein the at least one metric includes at least one from among an amount of kilograms of carbon dioxide (CO2), a number of kilowatt-hours of electricity, and a number of dollars that relates to a measurement of a carbon social cost.

15. The computing apparatus of claim 10, wherein the processor is further configured to determine, based on the first information, the second information, and the at least one metric, at least one proposed mitigation action for reducing the carbon impact associated with the first entity,
wherein the report includes fourth information that relates to the at least one proposed mitigation action.

16. The computing apparatus of claim 15, wherein the at least one proposed mitigation action includes at least one from among a first mitigation action that relates to green architecture and design patterns, a second mitigation action that relates to a green cloud, a third mitigation action that relates to green engineering, a fourth mitigation action that relates to green machine learning, and a fifth mitigation action that relates to green mobility.

17. The computing apparatus of claim 16, wherein the third mitigation action that relates to green engineering comprises a mitigation action that relates to at least one from among a use of a particular programming language, a use of a platform that includes caching, and a use of a library that includes caching.

18. The computing apparatus of claim 16, wherein the fifth mitigation action that relates to green mobility comprises a mitigation action that relates to inducing users to exercise at least one green digital habit that corresponds to a sustainability score.

19. A non-transitory computer readable storage medium storing instructions for tracking carbon emissions, the storage medium comprising executable code which, when executed by a processor, causes the processor to:
receive first information that relates to an amount of energy that is consumed by a first entity within a predetermined time interval;
receive second information that relates to a location at which the energy is consumed and a technology used for generating the energy;
calculate, based on the first information and the second information, at least one metric that indicates a carbon impact associated with the first entity; and
generate a report that includes third information that relates to the carbon impact associated with the first entity.

20. The storage medium of claim 19, wherein when executed by the processor, the executable code further causes the processor to:
cause a display to display a dashboard that includes a graphical user interface (GUI) that provides at least one prompt for facilitating user input that relates to at least one from among the first information and the second information; and
after the report is generated, cause the display to display the third information via the GUI.
